(19) United States
(12) Patent Application Publication
(10) Pub. No.: US 2024/0373321 A1
(43) Pub. Date: Nov. 7, 2024

(54) METHOD, DEVICE AND COMPUTER PROGRAM PRODUCT FOR WIRELESS COMMUNICATION

(71) Applicant: ZTE Corporation, Shenzhen (CN)

(72) Inventors: Lin CHEN, Shenzhen (CN); Mengzhen WANG, Shenzhen (CN); Weiqiang DU, Shenzhen (CN); Wei LUO, Shenzhen (CN); Ying HUANG, Shenzhen (CN)

(21) Appl. No.: 18/674,429

(22) Filed: May 24, 2024

Related U.S. Application Data
(63) Continuation of application No. PCT/CN2021/139286, filed on Dec. 17, 2021.

(51) Int. Cl. H04W 40/24; H04W 74/0833; H04W 92/18

(52) U.S. Cl. CPC H04W 40/24; H04W 74/0833; H04W 92/18

(57) ABSTRACT

Method, device and computer program product for wireless communication are provided. A method includes: receiving, by a wireless communication terminal from a wireless communication node, a multi-path configuration for at least one of an indirect path or a direct path of the wireless communication terminal; and performing, by the wireless communication terminal, a data transmission via at least one of the direct path or the indirect path according to the multi-path configuration.

### CROSS-REFERENCE TO RELATED APPLICATION(S)

This application is a continuation of International Patent Application No. PCT/CN2021/139286, filed on Dec. 17, 2021. The entire contents of the before-mentioned patent application is incorporated by reference as part of the disclosure of this application.

### TECHNICAL FIELD

This document is directed generally to wireless communications, in particular to 5th generation (5G) wireless communication.

### BACKGROUND

With the development of wireless communication services, requirements for data transmission rate and the coverage of cellular network are increasing. Besides, applications such as public safety, social networks, near field data sharing, and local advertising strengthen people's needs for communicating with nearby people or devices (e.g., Proximity Services). The traditional cellular network has its limitation in data transmission rate and proximity service. Thus, D2D (Device-to-Device) communication technology emerges. D2D technology can reduce the burden on cellular networks, reduce battery power consumption of user equipment (UE), increase data transmission rates, and improve the robustness of the network. D2D technology is also known as Proximity Services (ProSe), unilateral link, Sidelink (SL) or through link. The interface between the devices is the PC5 interface.

### SUMMARY

The present disclosure relates to methods, devices, and computer program products for wireless communication corresponding to multi-path communication.

One aspect of the present disclosure relates to a wireless communication method. In an embodiment, the wireless communication method includes: receiving, by a wireless communication terminal from a wireless communication node, a multi-path configuration for at least one of an indirect path or a direct path of the wireless communication terminal; and performing, by the wireless communication terminal, a data transmission via at least one of the direct path or the indirect path according to the multi-path configuration.

Another aspect of the present disclosure relates to a wireless communication method. In an embodiment, the wireless communication method includes receiving, by a wireless communication terminal from a wireless communication node, a path configuration; and performing, by the wireless communication terminal, a data transmission via at least one of the direct path or the indirect path according to the path configuration.

Another aspect of the present disclosure relates to a wireless communication method. In an embodiment, the wireless communication method includes transmitting, by a first wireless communication node to a second wireless communication node, a request message comprising information of one or more candidate relay wireless communication terminals; and receiving, by the first wireless communication node from the second wireless communication node, a response message comprising information of path configuration corresponding to one or more candidate relay wireless communication terminals.

Another aspect of the present disclosure relates to a wireless communication method. In an embodiment, the wireless communication method includes receiving, by a second wireless communication node from a first wireless communication node, a request message comprising information of one or more candidate relay wireless communication terminals; and transmitting, by the second wireless communication node to the first wireless communication node, a response message comprising information of path configuration corresponding to one or more relay wireless communication terminals.

Another aspect of the present disclosure relates to a wireless communication terminal. In an embodiment, the wireless communication terminal includes a communication unit and a processor. The processor is configured to: receive, from a wireless communication node, a multi-path configuration for at least one of an indirect path or a direct path of the wireless communication terminal; and perform, by the wireless communication terminal, a data transmission via at least one of the direct path or the indirect path according to the multi-path configuration.

Another aspect of the present disclosure relates to a wireless communication terminal. In an embodiment, the wireless communication terminal includes a communication unit and a processor. The processor is configured to: receive, from a wireless communication node, a path configuration; and perform a data transmission via at least one of the direct path or the indirect path according to the path configuration.

Another aspect of the present disclosure relates to a wireless communication node. In an embodiment, the wireless communication node includes a communication unit and a processor. The processor is configured to: transmit, to a second wireless communication node, a request message comprising information of one or more candidate relay wireless communication terminals; and receive, from the second wireless communication node, a response message comprising information of path configuration corresponding to one or more candidate relay wireless communication terminals.

Another aspect of the present disclosure relates to a wireless communication node. In an embodiment, the wireless communication node includes a communication unit and a processor. The processor is configured to: receive, from a first wireless communication node, a request message comprising information of one or more candidate relay wireless communication terminals; and transmit, to the first wireless communication node, a response message comprising information of path configuration corresponding to one or more relay wireless communication terminals.

Various embodiments may preferably implement the following features:

Preferably, the direct path is a link between the wireless communication terminal and the wireless communication node via a Uu interface.

Preferably, the indirect path is a path comprising one or more links between wireless communication terminal and wireless communication terminal and a link between the wireless communication terminal and the wireless communication node via a Uu interface.

Preferably, the indirect path is a path comprising one or more first links and a second link, wherein the first links are wireless-communication-terminal-to-wireless-communication-terminal links (e.g., UE-to-UE links), between wireless communication terminal and wireless communication terminal and a the second link is between the wireless communication terminal and the wireless communication node via a Uu interface.

Preferably, the first links are links based on direct communication technologies.

Preferably, the multi-path configuration comprises a path indication (corresponding to a remote wireless communication terminal), and the path indication comprises at least one of:
an indication of at least one of the direct path or the indirect path,
a path identifier,
a relay wireless communication terminal identifier or aggregated wireless communication terminal identifier, or
an identifier of a corresponding cell or base station.

Preferably, the multi-path configuration comprises a path indication (corresponding to a Signaling Radio Bearer, SRB, or a Data Radio Bearer, DRB, of a remote wireless communication terminal), the path indication comprises at least one of:
an identifier of SRB or DRB;
a path indication corresponding to at least one of the indirect path or the direct path, a primary path indication, a secondary path indication,
a path identifier,
a cell group identifier corresponding to a direct path, a primary path or a secondary path,
a relay wireless communication terminal identifier or aggregated wireless communication terminal identifier corresponding to an indirect path, a primary path or a secondary path,
a PC5 RLC channel identifier or a PC5 logical channel identifier corresponding to the direct path, indirect path, primary path or secondary path,
a Uu logical channel identifier corresponding to the direct path, indirect path, primary path or secondary path,
a data split threshold, or
a data duplication indication.

Preferably, the multi-path configuration comprises a path indication (corresponding to a Control Plane, CP, or Data Plane, DP, of a remote wireless communication terminal), and the path indication comprises at least one of:
an indication of at least one of the direct path or the indirect path,
a path identifier,
a relay wireless communication terminal identifier or aggregated wireless communication terminal identifier for indirect path,
an identifier of a corresponding cell or base station for direct path, or
a CP or UP indication.

Preferably, the multi-path configuration comprises at least one of:
information for setting up, modifying, or releasing the direct or indirect path,
information of conflict-free random access resources corresponding to 4-step or 2-step random access type of the wireless communication terminal in the direct path,
a Uu RB configuration,
a PC5 Radio link Control, RLC, channel configuration,
a Uu RLC channel or logical channel configuration,
a bearer mapping between the Uu RB and the PC5 RLC channel, or
a bearer mapping between the Uu RB and the Uu RLC channel.

Preferably, the PC5 RLC channel or bearer configuration comprises at least one of:
a corresponding relay wireless communication terminal identifier or aggregated wireless communication terminal identifier,
configurations of logical channel for the PC5 RLC channel,
or an identifier of one or more served RBs.

Preferably, the Uu RB configuration comprises at least one of:
a Packet Data Convergence Protocol, PDCP, configuration of a Uu SRB of the wireless communication terminal;
a PDCP configuration of a Uu DRB of the wireless communication terminal; or
a Service Data Adaption Protocol, SDAP, configuration of a Uu DRB of the wireless communication terminal;

Preferably, the SDAP configuration comprises configurations for mapping of Quality of Service, QoS, flows to a Uu DRB.

Preferably, the wireless communication terminal transmits a data packet corresponding to a Uu RB to at least one of a PC5 interface or a Uu interface of the wireless communication terminal according to the Uu RB configuration.

Preferably, the wireless communication terminal transmits a multi-path request to the wireless communication node.

Preferably, the multi-path request comprises at least one of: a multi-path capability, a measurement result for a relay wireless communication terminal, a request for saving power, or a path request for at least one of the direct or indirect path.

Preferably, the wireless communication terminal performs a conflict-free random access procedure on the direct path according to the multi-path configuration.

Preferably, the wireless communication terminal performs at least one of the following operations according to the multi-path configuration: setting up at least one of the direct or indirect path, modifying at least one of the direct or indirect path, or releasing at least one of the direct or indirect path.

Preferably, the wireless communication terminal receives an activation or deactivation indication, to activate or deactivate at least one of the direct path or the indirect path.

Preferably, the activation or deactivation indication comprises at least one of:
a Radio Bearer, RB, identifier,
a path identifier,
an indication for activation or deactivation,
a direct path,
an indirect path,
a primary path,
a secondary path,
an indication of uplink transmission,
an indication of downlink transmission,
a Uu RLC channel identifier or a Uu logical channel identifier, or
a PC5 RLC channel identifier or a PC5 logical channel identifier.

Preferably, the wireless communication terminal receives one or more routing identifiers corresponding to a Uu RB, and the routing identifier comprises at least one of a target identifier or a path identifier.

Preferably, the wireless communication terminal receives routing information comprising at least one of: a target identifier, a path identifier, a next hop node identifier, a next hop node type, a hop count, a priority, or a weight value.

Preferably, the wireless communication terminal determines a next hop node according to a routing identifier, determines at lease one of a PC5 RLC channel or a Uu RLC channel according to a bearer mapping configuration, and delivers a data packet of corresponding Uu DRB to at least one of the PC5 RLC channel or Uu RLC channel.

Preferably, the wireless communication terminal transmits a direct path Radio Link Failure, RLF, indication or an indirect path RLF indication to the wireless communication node.

Preferably, the direct path RLF indication is transmitted to the wireless communication node via the indirect path.

Preferably, the indirect path RLF indication is transmitted to the wireless communication node via the direct path.

Preferably, the direct path RLF indication or the indirect path RLF indication comprises at least one of: a Uu link failure, a PC5 link failure, a wireless communication terminal to wireless communication terminal link failure, or a failure cause.

Preferably, the direct path RLF indication or the indirect path RLF indication further comprises at least one of: a relay wireless communication terminal identifier or aggregated wireless communication terminal identifier corresponding to a PC5 link or wireless communication terminal to wireless communication terminal link, or an MCG identifier or SCG identifier or cell identifier or distributed unit identifier corresponding to a Uu link.

Preferably, the wireless communication terminal transmits a multi-path capability to the wireless communication node.

Preferably, the path configuration comprises at least one of:
a QoS profile,
a Uu link quality threshold,
a PC5 link quality threshold,
a Channel Busy Ratio, CBR,
an available path comprising a direct path, an indirect path, or both of the direct path and indirect path,
a primary path indication,
a secondary path indication,
a data split threshold, or
a data duplication indication.

Preferably, upon receiving the path configuration, the wireless communication terminal selects the available path according to the path configuration.

Preferably, the wireless communication terminal selects the available path according to the path configuration comprises at least one of:
if a measured Uu link quality is higher than the Uu link quality threshold and the available path comprises the direct path, the wireless communication terminal selects the direct path;
if at least one of a measured PC5 link quality is higher than the PC5 link quality threshold or a measured CBR is lower than the CBR in the path configuration, and if the available path comprises the indirect path, the wireless communication terminal selects the indirect path;
if the measured Uu link quality is higher than the Uu link quality threshold, the measured PC5 link quality is higher than the PC5 link quality threshold, and the available path comprises both of the direct path and indirect path, the wireless communication terminal determines to split a data traffic to the direct path and the indirect path according to the data split threshold, the primary path indication, and the secondary path indication;
if the measured Uu link quality is higher than the Uu link quality threshold, the measured PC5 link quality is higher than the PC5 link quality threshold, and the available path comprises both of the direct path and indirect path, the wireless communication terminal determines to perform data duplication on the direct path and the indirect path according to the data duplication indication; or
if the QoS profile of the data to be transmitted matches one of the configured QoS profile, the wireless communication terminal selects the path based on the configured available path.

Preferably, the information of path configuration comprises at least one of:
one or more identifiers of the candidate relay wireless communication terminals;
layer-two identifiers, L2 ID, of the candidate relay wireless communication terminals;
Cell Radio Network Temporary Identifier, C-RNTI, of the candidate relay wireless communication terminals;
measurement results of the candidate relay wireless communication terminals;
a Protocol Data Unit, PDU, Session Resources To-Be-Added List corresponding to the wireless communication terminal; or
a Protocol Data Unit, PDU, Session Resources To-Be-Modified List corresponding to the wireless communication terminal.

Preferably, the PDU Session Resources To-Be-Added or To-Be-Modified List comprises at least one of:
PDU Session Resource Setup or modification Information corresponding to a secondary node, SN,
PDU Session Resource Setup or modification Information corresponding to a master node, MN, or
a PDU Session Aggregate Maximum Bit Rate of a secondary next generation radio access network, S-NG-RAN, node.

Preferably, the response message comprises at least one of:
one or more identifiers of the candidate relay wireless communication terminals;
one or more L2 IDs of the candidate relay wireless communication terminals;
Cell Radio Network Temporary Identifier, C-RNTI, of the candidate relay wireless communication terminals; a Uu radio bearer configuration of the wireless communication terminal;
a Uu RLC channel or logical channel configuration of the wireless communication terminal;
a PC5 RLC channel configuration between the wireless communication terminal and relay wireless communication terminals;
a bearer mapping between the Uu RB of the wireless communication terminal and the Uu RLC RLC channel of the wireless communication terminal, or
a bearer mapping between the Uu RB of the wireless communication terminal and the PC5 RLC channel of the wireless communication terminal.

Preferably, the information of path configuration comprises at least one of:
one or more identifiers of the candidate relay wireless communication terminals;
layer-two identifiers, L2 ID, of the candidate relay wireless communication terminals;
Cell Radio Network Temporary Identifier, C-RNTI, of the candidate relay wireless communication terminals;
measurement results of the candidate relay wireless communication terminals;
a Protocol Data Unit, PDU, Session Resources To-Be-Added List corresponding to the wireless communication terminal; or
a Protocol Data Unit, PDU, Session Resources To-Be-Modified List corresponding to the wireless communication terminal.

Preferably, the PDU Session Resources To-Be-Added or To-Be-Modified List comprises at least one of:
PDU Session Resource Setup or modification Information corresponding to a secondary node, SN,
PDU Session Resource Setup or modification Information corresponding to a master node, MN, or
a PDU Session Aggregate Maximum Bit Rate of a secondary next generation radio access network, S-NG-RAN, node.

Preferably, the second wireless communication node transmits a configuration message to a selected relay wireless communication terminal, and the configuration message comprises at least one of:
an identifier of a remote wireless communication terminal,
a Uu RLC channel configuration,
a PC5 RLC channel configuration,
a bearer mapping between the Uu RB of the wireless communication terminal and the Uu RLC channel of wireless communication terminal, or
a bearer mapping between the Uu RB of the wireless communication terminal and the PC5 RLC channel of wireless communication terminal.

Preferably, the response message comprises at least one of:
one or more identifiers of the candidate relay wireless communication terminals;
one or more L2 IDs of the candidate relay wireless communication terminals;
Cell Radio Network Temporary Identifier, C-RNTI, of the candidate relay wireless communication terminals;
a Uu radio bearer configuration of the wireless communication terminal;
a Uu RLC channel or logical channel configuration of the wireless communication terminal;
a PC5 RLC channel configuration between the wireless communication terminal and relay wireless communication terminals;
a bearer mapping between the Uu RB of the wireless communication terminal and the Uu RLC RLC channel of the wireless communication terminal, or
a bearer mapping between the Uu RB of the wireless communication terminal and the PC5 RLC channel of the wireless communication terminal.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a Sidelink relay communication according to an embodiment of the present disclosure.

FIGS. 2a to 2c show a schematic diagram of different types of the multi-path communication for a remote UE according to an embodiment of the present disclosure.

FIGS. 3a and 3b show a procedure for the multi-path communication according to an embodiment of the present disclosure.

FIGS. 4a to 4c show another procedure for the multi-path communication according to an embodiment of the present disclosure.

FIG. 5 shows a schematic diagram of a wireless communication terminal according to an embodiment of the present disclosure.

FIG. 6 shows a schematic diagram of a wireless communication node according to an embodiment of the present disclosure.

FIG. 7 shows a flowchart of a wireless communication method according to an embodiment of the present disclosure.

FIG. 8 shows a flowchart of another wireless communication method according to an embodiment of the present disclosure.

FIG. 9 shows a flowchart of another wireless communication method according to an embodiment of the present disclosure.

FIG. 10 shows a flowchart of another wireless communication method according to an embodiment of the present disclosure.

### DETAILED DESCRIPTION OF EMBODIMENTS

In order to support various of applications such as indoor relay communications, smart agriculture, smart factories, and public safety, Sidelink relay communications can be used to expand service coverage and reduce power consumption. Sidelink relay communications may have the following two scenarios:

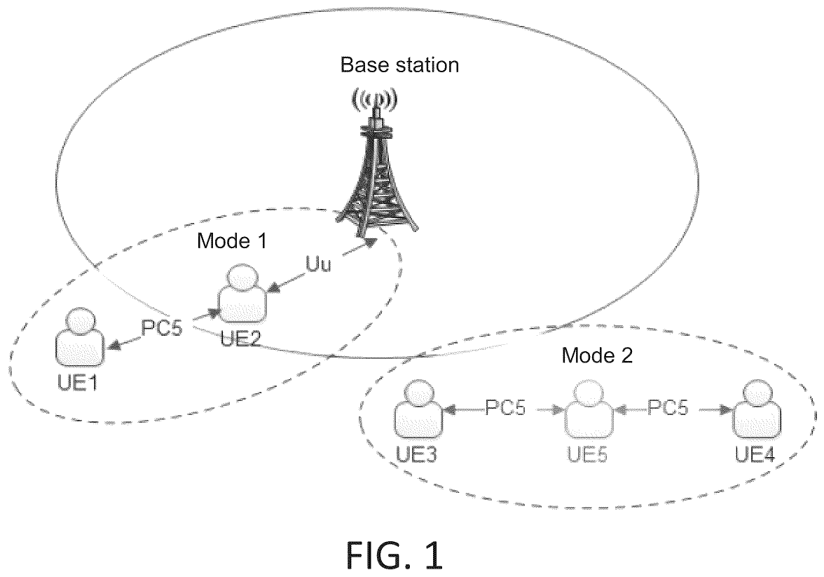

1) UE-to-Network (U2N) relay: A UE relay transmission in weak or no network coverage area, as shown in Mode 1 in FIG. 1, allows the UE1 with poor signal quality or no signal to communicate with the network through a nearby UE2 within network coverage. In such a manner, it can help operators to expand network coverage. The UE2 is called a UE-to-Network relay, and the UE1 is called a remote UE.

2) UE-to-UE relay: In case of an earthquake or another emergency event, the cellular network cannot work normally. In this case, devices may communicate with each other through a relay UE. For example, in Mode 2 of FIG. 1, data communication is carried out between the UE3 and the UE4 through the UE5. In this case, UE5 is called a UE-to-UE relay.

For UE-to-Network relay, there are two perspectives of technical solution, one is based on the IP (Internet Protocol) layer (i.e., Layer 3 or L3) and another one is based on the access layer (i.e., Layer 2 or L2). The Layer 3 (i.e., IP layer) relay forwards data based on information such as the target IP address and/or the port number. The Layer 2 (access layer) relay UE performs routing and forwarding data of the control plane and the user plane at the access layer. With such a configuration, operators (e.g., operators of core network elements and base stations) can manage remote UEs more effectively. For remote UEs within the coverage of a cellular network, in addition to access the network through the relay UE for data transmission, they can also communicate directly with the base station for data transmission, so that the data transmission rate and robustness can be improved. The present disclosure provides solutions for the scenario where the remote UE performs data transmission with the base station through the direct connection of the Uu interface and the indirect path through the relay UE at the same time. In some embodiments, the present disclosure also provides solutions of triggering conditions of the update of the path configuration, configuration methods for multiple paths, activation and deactivation methods of multiple paths, and a reporting method for path unavailability.

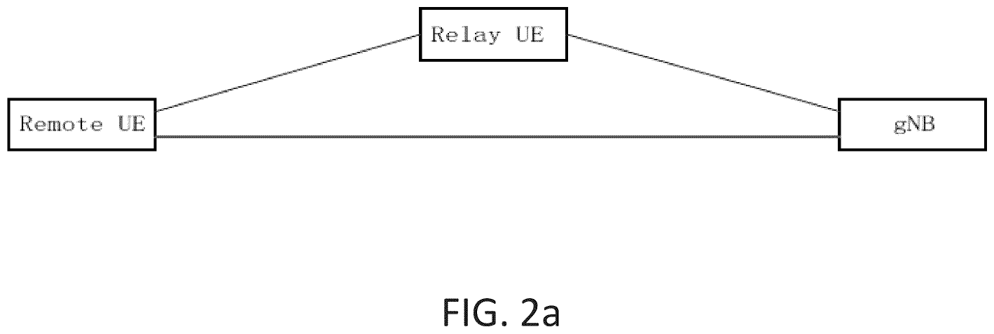

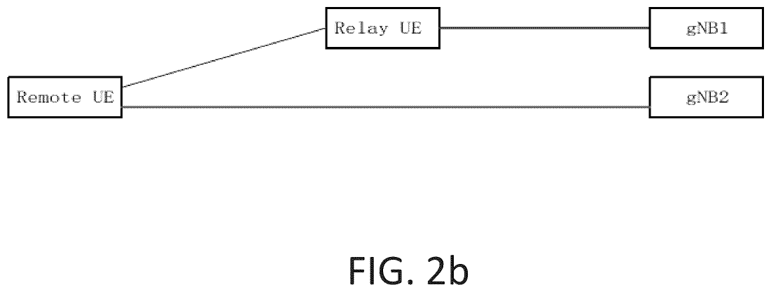

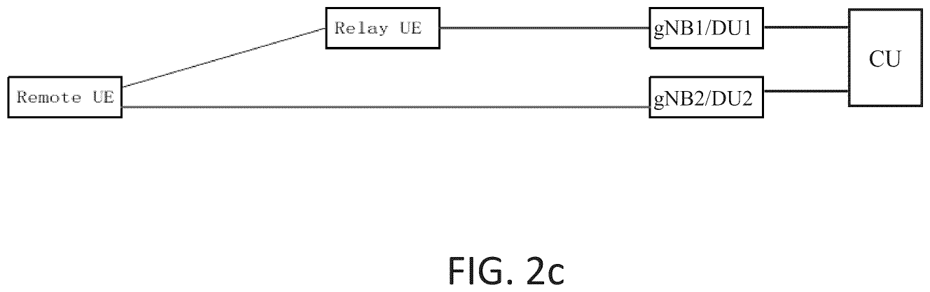

In the single hop U2N (User Equipment (UE) to Network) scenario, there are different types of paths, as shown in FIGS. 2a and 2b.

1) The indirect path (e.g., a PC5 path) in which the remote UE transmits data to the base station (e.g., the gNB (gNodeB) or the gNB1) through the PC5 interface of the remote UE and one or more relay UEs.

2) The direct path (e.g., a Uu path) in which the remote UE directly transmits data to the base station (e.g., the gNB or the gNB2) through the Uu interface of the remote UE.

It should be noted that the indirect path and the direct path may be connected to the same gNB (see FIG. 2a) or different gNBs (see FIG. 2b). Besides, if the remote UE has multiple indirect paths, these indirect paths may also correspond to the same or different gNBs. In some embodiment, the gNB1 and the gNB2 in FIG. 2b can also be regarded as two different gNB-DUs (distributed units) (e.g., DU1 and DU2) (also referred to as DU) under the same gNB-CU (Central Unit) (also referred to as CU) (also see FIG. 2c). In some embodiments, the base station mentioned in the present disclosure can be at least one of the gNB, the gNB1, the gNB2, or the CU.

From the perspective of granularity of multi-path data transmission, there are the following situations:

(1) The CP (control plane) data and the UP (user plane) data are transmitted through different paths: this can be applied to the scenarios of FIGS. 2a to 2c.

(2) Different RBs (Radio Bearers) are transmitted through different paths: this can be applied to the scenarios of FIGS. 2a to 2c.

(3) The data of the same RB is transmitted through different paths, which may include data split and data duplication scenarios. It can be applied to the scenarios in FIGS. 2a to 2c. For the scenario involving multiple gNBs in FIG. 2b, to ensure the ordering of data of the same RB, the PDCP (Packet Data Convergence Protocol) layers of different gNBs corresponding to the data of the same RB may be anchored on the same base station, which can be MCG (Master Cell Group) terminated or SCG (Secondary Cell Group) terminated.

(4) Different QoS (Quality of Service) flows are transmitted through different paths: it can be applied to the scenarios in FIGS. 2a to 2c. Similar to the MR-DC (Multi-Radio Dual Connectivity), different QoS flows can be mapped to different DRBs (Data Radio Bearers), and different DRBs may correspond to SCG bearer, MCG bearer, or split bearer. In some cases, this method uses different bearer types to implement multi-path transmission with granularity at the RB (Radio Bearer) level, which is similar to the situations (2) and (3) described above.

In some methods, for the L2 U2N relay, the remote UE can only access one relay UE or gNB, and cannot access the relay UE and gNB at the same time. In some embodiments, the L2 remote UE needs to be enhanced to connect to the relay UE and the gNB at the same time. For the L3 U2N relay, the remote UE can connect to the relay UE and the gNB at the same time, and the base station has no information about whether the remote UE is connected to the relay UE and which traffic is forwarded by the relay UE. This also means that in the L3 U2N relay scenario, the determinations for multi-path communication mainly rely on the remote UE.

In some embodiments of the present disclosure described below, designs for relays in L2 and L3 are provided.

In accordance with some embodiments of the present disclosure, the base station can transmit a multi-path configuration for at least one of an indirect path or a direct path for the remote UE to the remote UE. The remote UE can perform a data transmission via at least one of the direct path or the indirect path according to the multi-path configuration.

In accordance with some embodiments of the present disclosure, the direct path is a link between the UE and the gNB via a Uu interface. In an embodiment, the indirect path is a path including one or more links between UEs and a link between the remote UE and the gNB via a Uu interface, in which the links between UEs may be links based on direct communication technologies.

In accordance with some embodiments of the present disclosure, the multi-path configuration may include at least one of:
a path indication,
information for setting up, modifying, or releasing the direct or indirect path,
information of conflict-free random access resources corresponding to 4-step or 2-step random access type of the remote UE in the direct path,
a Uu RB configuration,
a PC5 Radio link Control, RLC, channel configuration,
a Uu RLC channel or logical channel configuration,
a bearer mapping between the Uu RB and the PC5 RLC channel, or
a bearer mapping between the Uu RB and the Uu RLC channel.

In different embodiments, the path indication may correspond to different granularities.

In some embodiments, when the path indication corresponds to the remote UE, the path indication includes at least one of:
an indication of at least one of the direct path or the indirect path,
a path identifier,
a relay UE identifier or aggregated UE identifier, or
an identifier of a corresponding cell or base station.

In some embodiments, when the path indication corresponds to a Signaling Radio Bearer (SRB) or a Data Radio Bearer (DRB) of a remote UE, the path indication includes at least one of:
an identifier of SRB or DRB;
a path indication corresponding to at least one of the indirect path or the direct path, a primary path indication, a secondary path indication,
a path identifier,
a cell group identifier corresponding to a direct path, a primary path or a secondary path,
a relay UE identifier or UE identifier corresponding to an indirect path, a primary path or a secondary path,
a PC5 RLC channel identifier or a PC5 logical channel identifier corresponding to the direct path, indirect path, primary path or secondary path,
a Uu logical channel identifier corresponding to the direct path, indirect path, primary path or secondary path,
a data split threshold, or
a data duplication indication.

In some embodiments, when the path indication corresponds to a Control Plane (CP) or Data Plane (DP) of the remote UE, the path indication comprising at least one of:
an indication of at least one of the direct path or the indirect path,
a path identifier,
a relay UE identifier or aggregated UE identifier for indirect path,
an identifier of a corresponding cell or base station for direct path, or
a CP or UP indication.

With the multi-path configuration described above, the remote UE can perform a data transmission via at least one of the direct path or the indirect path.

Details of the operations and configurations are described in the examples below, but the present disclosure is not limited to these examples.

### Example 1

In some embodiments, for an L2 U2N relay, if it is needed to support multi-path communication, there is a need to explicitly configure which RB uses which path for the remote UE. Specifically, the following perspective are discussed:

### 1) Rb Granularity:

In some embodiments, under the scenario shown in FIG. 2a, when the gNB sends the Uu RB configuration to the remote UE, the gNB indicates the transmission path used by the corresponding Uu RB. The transmission path can be indicated as the indirect path and/or the direct path. Further, it can also be indicated as the PC5 and/or Uu interface. After the remote UE receives the uplink data packet from the higher layer, the remote UE looks up for the transmission path corresponding to the Uu RB data packet. If the transmission path corresponds to the indirect path or the PC5 interface, the remote UE delivers the data packet to the Adaptation layer and/or RLC (Radio link Control) channel corresponding to the PC5 interface for subsequent transmission. If the transmission path corresponds to the direct path or the Uu interface, the remote UE sends the data packet to the RLC channel corresponding to the Uu interface for subsequent transmission.

To be specific, after the PDCP (Packet Data Convergence Protocol) layer of the remote UE completes the encryption and/or compression processing, the remote UE further looks up for the transmission path associated with the Uu RB corresponding to the data packet. If the transmission path corresponds to the indirect path or the PC5 interface, the remote UE delivers the data packet to the RLC channel corresponding to the PC5 interface for subsequent transmission. If the transmission path corresponds to the direct path or the Uu interface, the remote UE delivers the data packet to the RLC channel corresponding to the Uu interface for subsequent transmission.

In an embodiment, if the Adaptation layer or the PDCP layer determines that the data packet needs to be transmitted through the PC5 interface, the Adaptation layer further delivers the information of a source L2 ID (identifier or identification) and a destination L2 ID corresponding to the data packet to the bottom layer for the MAC (Medium Access Control) layer encapsulating the MAC subheader subsequently.

For another scenario, when the gNB sends the Uu RB configuration to the remote UE, it sends the route identifier corresponding to the Uu RB. The route identifier can include any combination of the following: a target identifier or a path identifier. In this scenario, the gNB may further send the routing table to the remote UE and the relay UE(s) between the gNB and the remote UE. The routing table includes any combination of the following information: a target ID, path ID, a next hop node ID, a next hop node type, a hop count, a priority or a weight value. The target identifier may be the target base station identifier or the target cell identifier, and the next hop node identifier may be the relay UE identifier or the base station or cell identifier of the next hop transmission. The next hop node type can be a UE or a base station or a DU or a cell group (such as MCG or SCG). After the remote UE receives the uplink data packet from the higher layer, it looks for the route identifier corresponding to the data packet Uu DRB. The Adaptation layer can add the routing identifier to the Adaptation layer subheader. The Adaptation layer looks up the routing table according to the routing identifier and determines the next hop node. According to the bearer mapping configuration received from the base station, the Adaptation layer further determines the corresponding PC5 RLC channel, delivers the data packet to the corresponding RLC channel, and then transmits it to the corresponding next hop node. When the relay UE receives the data packet, the relay UE determines the next hop node and deliver the data packet to the Uu RLC channel according to the routing identifier of the Adaptation layer subheader, and then sends it to the corresponding base station or cell through the Uu interface.

For the scenario involving multiple gNBs shown in FIG. 2b above, from the perspective of the remote UE, these two gNBs can be regarded as the MCG and SCG of the remote UE. The MCG and SCG can communicate about the remote UE's bearer configuration and routing configuration through the Xn interface. In an embodiment, the remote UE can also be regarded as a single-connection UE connected to only one base station. For example, the UE only establishes an RRC (Radio Resource Control) connection with gNB1. In this case, gNB2 can be regarded as an intermediate node on another path. When the data packet transmitted between gNB2 and gNB1, the Adaptation layer subheader can be carried. The subheader of the Adaptation layer may contain the remote UE identifier and/or the bearer identifier. The Adaptation layer subheader transmitted on the Xn interface can be used for the gNBs to identify the routing path of the data packet and the bearer of the corresponding remote UE, so as to perform subsequent routing and forwarding or support in-order delivery of the PDCP layer data packet to the higher layer.

### 2) QoS Flow Granularity:

In some embodiments, the UE receives the SDAP (Service Data Adaption Protocol) configuration from the base station, which includes the QoS flows corresponding to the Uu DRB (Data Radio Bearer). The Uu DRB can be further configured as an MCG bearer, an SCG bearer or a split bearer. For example, the MCG bearer may correspond to the direct path, and the SCG bearer may correspond to the indirect path. This method can be used to scenarios where the direct path and the indirect path are associated with different gNBs or DUs.

For the scenario where the direct path and the indirect path are associated with the same base station, the UE receives the SDAP configuration from the base station, where the SDAP configuration indicates the QoS flows corresponding to the Uu DRB.

In an embodiment, the Uu DRB configuration received by the UE from the base station can be associated with one or two RLC channels, and the RLC channel can be a PC5 RLC channel or a Uu RLC channel. If the Uu DRB configuration of the UE is associated with two RLC channels via different interface, it means that multi-path communication is used for transmission. The multi-path communication can be based on data split or data duplication. In the case of data split, the base station configures at least one of the following fields: the threshold of the data split corresponding to the DRB, the RLC channel ID, and/or the logical channel ID corresponding to the primary path for the UE. Besides, the base station may also configure the split type of the DRB for performing data split for the UE, such as random split, a distributing ratio of data transmission on two paths, and so on. In the case of data duplication, the base station configures the RLC channel ID or logical channel ID corresponding to the primary path for the UE.

In some embodiments, for activation or deactivation of multi-path communication, the base station can send a multi-path activation or deactivation indication to the UE through RRC signaling or MAC CE (Control Element), which may contain at least one of the following information: an activation or deactivation indication, direct path information, indirect path information, a primary path, a secondary path, an indication of uplink transmission and/or downlink transmission, a RB identifier, a Uu RLC channel ID, a Uu logical channel ID, a PC5 RLC channel ID, or a PC5 logical channel ID. In an embodiment, the direct path information may include a cell identifier or base station identifier corresponding to the MCG or SCG. The indirect path information can include a corresponding relay UE identifier. For example, a multi-path activation MAC CE sent by the base station to the UE includes an activation indication, indirect path information, direct path information, and an indication of uplink transmission. This means that the UE can subsequently transmit uplink data through the indirect path and the direct path.

### 3) Cp/Up Granularity:

In addition to the path indication mentioned above, the UE can receive CP/UP granularity path configuration from the base station. For example, the CP path indication received by the UE may be direct path information, indirect path information, or both. The UP path may be indicated as direct path information, indirect path information, or both. In an embodiment, the direct path information may include a cell identifier or base station identifier corresponding to the MCG or SCG. The indirect path information can include the corresponding relay UE identifier.

### Example 2

In this example, reference is made to FIG. 2a, in which the direct path and indirect path of the remote UE are connected to the same cell or DU or gNB.

In this scenario, the remote UE can have the following initial states:

(1) The remote UE only accesses the gNB initially, and subsequently accesses the relay UE without releasing the gNB.

In this case, the control plane and user plane data of the remote UE are initially transmitted through the gNB. Then, because the remote UE moves to the edge of the cell, to save power or to improve the reliability of data transmission or the data transmission rate, the gNB configures the remote UE to transmit data to the network via the relay UE. In an embodiment, the remote UE may send measurement information about the relay UE (such as a relay UE ID, PC5 RSRP (Reference Signal Received Power) measurement results, relay UE's NCGI (New Radio Cell Global Identifier) or cell ID information) to the gNB. In an embodiment, the remote UE can send a multi-path configuration request to the gNB (such as via the Uu and/or PC5 interface), or the remote UE sends a power saving request to the gNB, which may trigger the gNB to send the multi-path configuration to the remote UE.

In an embodiment, the gNB may receive the QoS profile information of the QoS flow of the remote UE from the AMF. When there is a high requirement for PER (packet error rate), it will also trigger the gNB to send the multi-path configuration to the remote UE.

In some embodiments, the multi-path configuration may include the path indication. The path indication can be per remote UE, per remote UE SRB (Signaling Radio Bearer), per remote UE DRB, or per CP/UP. The path indication can include the Uu and/or PC5 path. When the path indication includes a PC5 path, the path indication may further indicate a corresponding relay UE identifier. When the path indication corresponds per remote UE SRB or per remote UE DRB, the path indication may further include at least one of a primary path indication or a secondary path indication per Uu or PC5 path, a data split threshold, or a data duplicate indication. Besides, the multi-path configuration can also include the RLC channel configuration on the corresponding path. For example, in a scenario where the PC5 path is configured, the multi-path configuration can include any combination of the following information: the PDCP configuration of the RB of the remote UE, the SDAP configuration of the DRB of the remote UE, the configuration of the PC5 RLC channel, and/or the bearer mapping configuration from the DRB or SRB of the remote UE to the PC5 RLC channel. For scenarios where the Uu path is configured, the multi-path configuration may include the PDCP, RLC, or logical channel configuration of the Uu RB of the remote UE, and/or the SDAP configuration of the Uu DRB of the remote UE.

After receiving the multi-path configuration, the remote UE performs data transmission and reception according to the multi-path configuration.

(2) The remote UE only accesses the relay UE initially, and subsequently accesses the gNB without releasing the relay UE.

In this case, the control plane and user plane data of the remote UE are initially transmitted through the relay UE. Then, because the remote UE moves to the center of the cell, to increase the reliability or speed of data transmission, the gNB configures the remote UE to allow the remote UE to transmit data to the network directly via the gNB. In an embodiment, the remote UE may send (e.g., via the relay UE) measurement information about the relay UE (such as a relay UE ID, PC5 RSRP (Reference Signal Received Power) measurement results, relay UE's NCGI (New Radio Cell Global Identifier) or cell ID information) to the gNB. In an embodiment, the remote UE can send a multi-path configuration request to the gNB (such as via the Uu and/or PC5 interface), or the remote UE sends a power saving request to the gNB, triggering the gNB to send the multi-path configuration to the remote UE. In an embodiment, the gNB may receive the QoS profile information of the QoS flow of the remote UE from the AMF (Access and Mobility Management Function). When there is a high requirement for PER (packet error rate) in the QoS profile (e.g., exceeding a certain threshold), it will also trigger the gNB to send the multi-path configuration to the remote UE. In an embodiment, the gNB may detect that the SL (Sidelink) resource pool is congested while the Uu resources are relatively idle, which triggers the gNB to send a multi-path configuration to the remote UE, allowing the remote UE to transfer part of the data flow forwarded by the relay to the Uu interface for the direct transmission.

Specifically, the path indication may be included in the multi-path configuration. The path indication can correspond to per remote UE, per remote UE SRB, per remote UE DRB, or per CP or UP. The path indication can include information of the Uu and/or PC5 path. For scenarios of the path indication containing information of the PC5 path, the path indication may further indicate the corresponding relay UE identifier. For scenarios of the path indication containing information of the Uu path, the path indication may further indicate the corresponding base station identifier or cell identifier. The path indication corresponding to per remote UE SRB or per remote UE DRB may further include at least one of a primary path indication or a secondary path indication per Uu or PC5 path, a data split threshold, or a data duplicate indication. Besides, the multi-path configuration can also include the RLC channel configuration of the corresponding path. For example, in a scenario where the PC5 path is configured, the multi-path configuration can include any combination of the following information: the PDCP configuration of the remote UE RB, the SDAP configuration of the remote UE DRB, the configuration of the PC5 RLC channel, and/or a bearer mapping configuration from the DRB or SRB of the remote UE to the PC5 RLC channel. For scenarios where the Uu path is configured, the multi-path configuration may include the PDCP or RLC or logical channel configuration of the remote UE Uu RB, and/or the SDAP configuration of the remote UE Uu DRB. In an embodiment, the multi-path configuration may also include the conflict-free random access resources corresponding to the 4-step or 2-step RA (random access) type performed by the remote UE in the Uu path.

After receiving the multi-path configuration, the remote UE performs a random access procedure on the Uu path according to the multi-path configuration. The remote UE sends an RRCReconfigurationComplete message to the base station, and then, the remote UE can transmit and receive a part of the data flow through the Uu interface according to the multi-path configuration.

(3) The remote UE accesses both of the relay UE and the gNB initially, and subsequently releases the relay UE.

In this case, the remote UE initially performs the multi-path transmission for the control plane and user plane data through the relay UE and the gNB. Later, because the remote UE moves to the cell center, SL resources are congested, or because the remote UE no longer has requirements for high data transmission reliability and transmission rate, the gNB configures the remote UE to only transmit data through the direct path. In an embodiment, the remote UE sends (forwarded by the relay UE) the Uu measurement information (such as a cell ID and a Uu RSRP measurement result) of the gNB and/or the PC5 measurement result of the relay UE to the gNB. In an embodiment, the remote UE can send a multi-path configuration request to the gNB (e.g., via the Uu path), or the remote UE sends an uplink congestion mediation indication to the gNB, to trigger the gNB to send a multi-path configuration update to the remote UE. In an embodiment, the gNB may receive the PDU session update information for the remote UE from the AMF. If a QoS flow requiring high PER is released, it will also trigger the gNB to send a multi-path configuration update to the remote UE.

In an embodiment, the path indication may be included in the multi-path configuration. The path indication can correspond to per remote UE, per remote UE SRB, per remote UE DRB, or per CP or UP. The path indication can include information of the Uu path and or PC5 path. For scenarios of the path indication containing Uu path, the path indication may further indicate the corresponding base station identifier or cell identifier. The path indication corresponding to per remote UE SRB or per remote UE DRB may further include at least one of a primary path indication or a secondary path indication per Uu or PC5 path, a data split threshold, a data duplicate indication. Besides, the multi-path configuration can also include the RLC channel configuration on the corresponding path. For example, in a scenario where the Uu path is configured, the multi-path configuration can include any combination of the following information: the PDCP configuration of the remote UE RB, the SDAP configuration of the remote UE DRB, the configuration of the Uu RLC channel, and/or a bearer mapping configuration from the DRB or SRB of the remote UE to the Uu RLC channel. For the RB, UP, or CP data originally configured with the Uu path, the multi-path configuration may update corresponding configurations to make them be configured with the corresponding PC5 path.

After receiving the multi-path configuration, the remote UE sends the RRCReconfigurationComplete message on the PC5 path according to the multi-path configuration to the gNB. After that, the remote UE can transmit and receive data through the PC5 interface according to the multi-path configuration.

(4) The remote UE accesses both of the relay UE and the gNB at the same time, and subsequently releases the gNB.

When the remote UE moves to the edge of the cell, the base station may configure the remote UE to only transmit and receive data through the relay UE according to the measurement result. Similar to the embodiments for the initial state (3) described above, the gNB can send the multi-path configuration update information to the remote UE, including a Uu path setup, modification, or release. The multi-path configuration update information can also include a PC5 path setup, modification, or release. In an embodiment, the base station can send related configurations through RRC signaling for the establishment, update and release of the multi-path connection.

In an embodiment, the base station can also send a Uu and/or PC5 path activation or deactivation indication to the remote UE that maintains the Uu interface connection with the base station through the MAC CE. Specifically, the MAC CE may contain any combination of the following information: an RB ID, a path indication, or activation or deactivation indication. After receiving the MAC CE, the remote UE only uses the activated path to send and receive data corresponding to the bearer.

### Example 3

In this example, reference is made to FIG. 2b, in which the direct path and indirect path of the remote UE are connected to the different cells or DUs or gNBs.

In this example, the remote UE can have the following initial states:

(1) The remote UE only accesses the gNB2 initially, and subsequently accesses both of the relay UE and the gNB2.

In this case, the control plane and user plane data of the remote UE are initially transmitted through the gNB2. Then, to save power or to improve the reliability of data transmission or data transmission rate, the remote UE is configured to be able to simultaneously accesses the relay UE and gNB2 for data transmission to the network. In an embodiment, the remote UE sends to the gNB2 the measurement information of the relay UE (such as a relay UE ID, a PC5 RSRP measurement results, the relay UE's NCGI or cell ID information), multi-path configuration request (such as the Uu path and/or the PC5 path), or the remote UE sends a power saving request to the gNB2, which triggers the gNB2 to send the multi-path configuration to the remote UE.

In an embodiment, the gNB2 selects the relay UE served by gNB1. In an embodiment, some methods can be considered: (1) the gNB2 initiates the configuration of MR-DC (Multi-Radio Dual Connectivity) for the remote UE, where the gNB2 is served as the MN and the gNB1 can be served as the SN; (2) the gNB1 and the gNB2 are regarded as the DU1 and the DU2 connected to the same gNB-CU (see FIG. 2c), where the DU2 is served as the MN of MR-DC, and the DU1 is served as the SN of MR-DC; (3) maintain the single connection of remote UE, and use the gNB1 as a gNB type relay node, and transmit the data packet between the remote UE and the gNB through the relay UE.

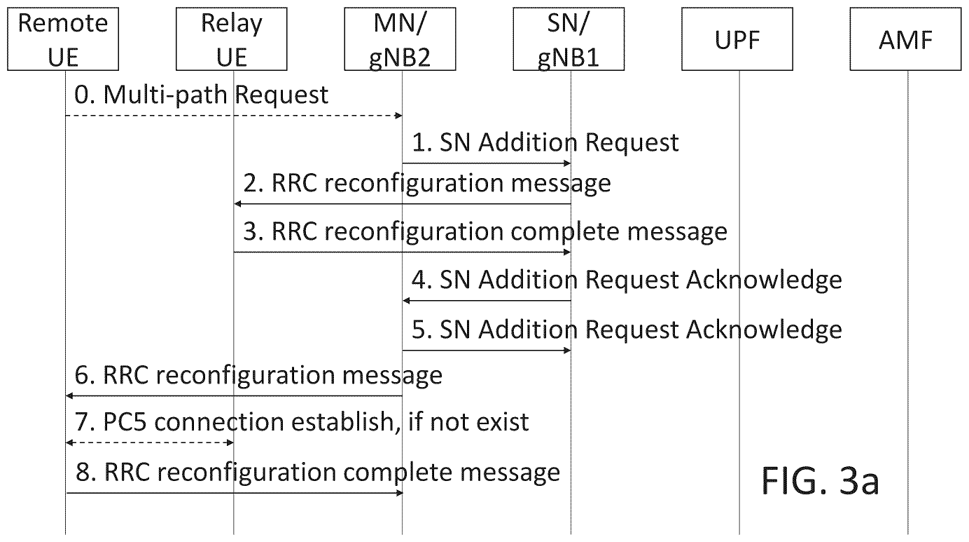

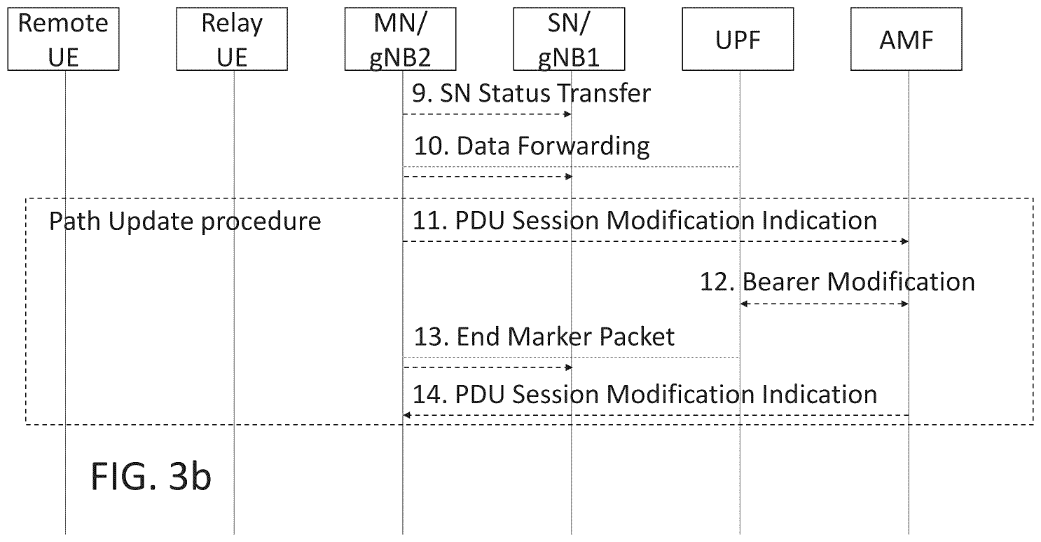

For the method (1) described above, reference is made to FIGS. 3a and 3b. In an embodiment, after receiving a multi-path request (operation 0), the MN sends an SN Addition request to the SN (operation 1), where the SN Addition request includes information about one or more candidate relay UEs served by gNB1 (for example, it may include L2 IDs or C-RNTIs for the candidate relay UEs, and/or the measurement results of the candidate relay UEs by the remote UE), and an indication that the trigger of the SN addition request can be a multi-path relay event. In an embodiment, the SN addition request can include the PDU Session Resources To-Be-Added List/To-Be-Modified List corresponding to the remote UE, which can include at least one of the PDU Session Resource Setup Info-SN terminated, PDU Session Resource Setup Info-MN terminated, or a PDU Session Aggregate Maximum Bit Rate of the S-NG-RAN (secondary next generation radio access network) node.

After receiving the information, the SN determines the Uu RB configuration of the corresponding the remote UE. Further, the SN can select a suitable relay UE according to the information of candidate relay UEs received from the MN. In an embodiment, the SN determines the configurations of the relay UE and the remote UE corresponding to the Uu RB data transmission of the remote UE. For example, the SN sends an RRCReconfiguration message to the relay UE (operation 2), which contains at least one of the following information: a remote UE identifier (e.g., an L2 ID and/or a local ID assigned by the SN and/or a C-RNTI), a Uu RLC channel configuration, a PC5 RLC channel configuration, the bearer mapping between the Uu RB and the Uu RLC channel of the remote UE, and the bearer mapping between the Uu RB and the PC5 RLC channel of the remote UE. After receiving an RRC reconfiguration complete message from the relay UE (operation 3), the SN sends an SN addition request acknowledge message to the MN (operation 4), which may include at least one of the following information: one or more identifiers of the candidate relay UEs, one or more L2 IDs of the candidate relay UEs; C-RNTI of the candidate relay UEs; a Uu radio bearer configuration of the remote UE; a Uu RLC channel or logical channel configuration of the remote UE; a PC5 RLC channel configuration between the remote UE and relay UEs; a bearer mapping between the Uu RB of the remote UE and the Uu RLC RLC channel of the remote UE, or a bearer mapping between the Uu RB of the remote UE and the PC5 RLC channel of the emote UE. If the SN requests the MN to create a DRB of the UE1, the MN may send an SN Reconfiguration Complete message to the SN (operation 5). After that, the MN will send an RRCReconfiguration message to the remote UE (operation 6), which can contain at least one of the following information: (a) a Uu RB configuration (for example, the PDCP of the Uu SRB of the remote UE, or the PDCP and SDAP configuration of the Uu DRB), (b) the remote UE identifier (e.g., a local ID and/or C-RNTI assigned by the SN), (c) a relay UE identifier (such as an L2 ID or a local ID or a C-RNTI allocated by the MN or SN), (d) a PC5 RLC channel configuration (e.g., including at least one of the following information: an identifier of a corresponding relay UE, configurations of RLC and logical channel for the PC5 RLC channel, or an identifier of a served RB), or (e) the bearer mapping of the Uu RB and the PC5 RLC channel. In an embodiment, the PC5 RLC channel configuration can be contained in the cellGroupConfig corresponding to the SN. In an embodiment, the SDAP configuration may be updated so that some QoS flows are mapped to the Uu RB associated with the PC5 RLC channel. In an embodiment, the configuration sent by the MN to remote UE can indicate at least one of the following information: a cell group identifier or a relay identifier corresponding to a primary path, a PC5 RLC channel identifier or a PC5 logical channel identifier corresponding to a primary path, a data split threshold, an indication for PDCP duplication, a cell group identifier or a relay identifier corresponding to a split secondary path, a PC5 RLC channel identifier or a PC5 logical channel identifier corresponding to a split secondary path, or a duplication status.

After the remote UE receives the RRCReconfiguration message sent by the MN, if the remote UE has not established a PC5 connection with the relay UE, the remote UE can initiate the establishment of a PC5 connection with the relay UE configured by the SN (operation 7). The remote UE sends an RRCReconfigurationComplete message to the MN (operation 8). After receiving the RRCReconfigurationComplete message, the MN can perform SN Status Transfer procedure (operation 9) and send downlink data packets to the SN if necessary (operation 10). In an embodiment, the MN may also perform a path update procedure with the AMF (operations 11 to 14). In an embodiment, the remote UE can perform multi-path uplink transmission through the direct link and the indirect link according to the RRCReconfiguration sent by the MN.

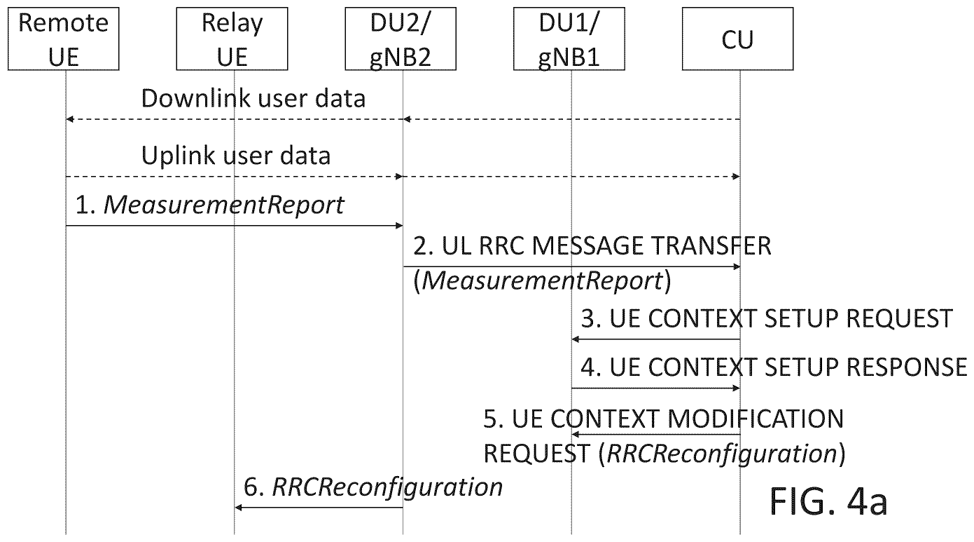

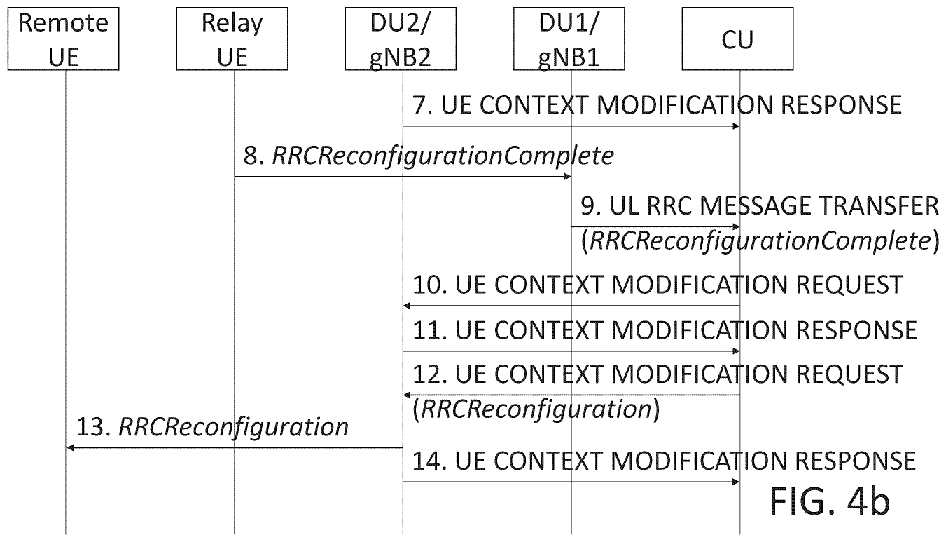

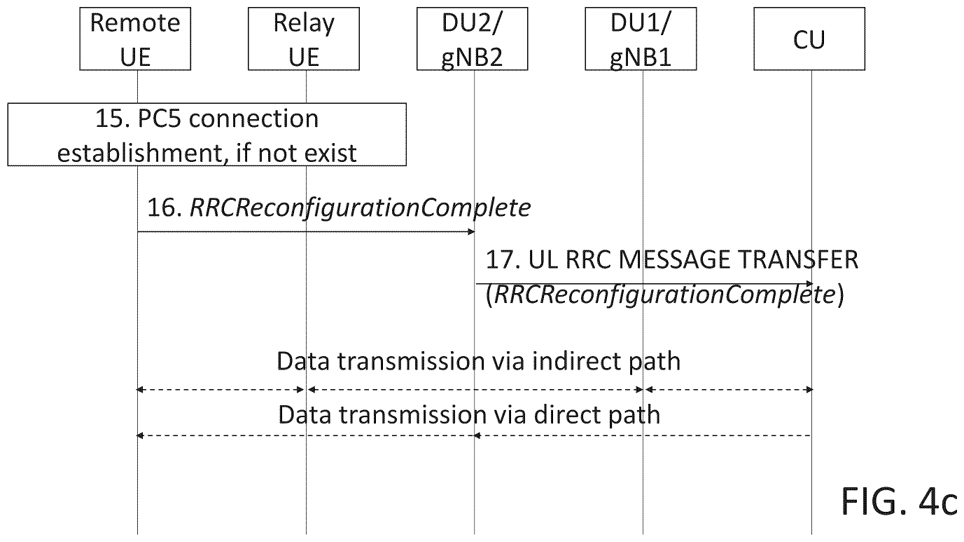

For the method (2) described above, the gNB1 and the gNB2 are regarded as the DU1 and the DU2 connected to the same gNB-CU (also referred to as CU) (as shown in FIG. 2c), where the DU2 is served as the MN of MR-DC, and the DU1 is served as the SN of MR-DC. In this scenario, reference is made to FIGS. 4a to 4c. The SCG can be added between the CU and the DU1 through an F1 interface process. For example, after the CU receives the measurement report of the remote UE via the DU2 (operations 1 and 2), the CU sends a UE Context Setup request message to the DU1 (operation 3), which contains any combination of the following information: a remote UE identifier, a Uu RLC channel to be setup request information, a PC5 RLC channel to be setup request, or a mapping between the Uu RB of the remote UE and the Uu RLC channel of the remote UE. The DU1 sends a UE Context Setup Response message to the CU (operation 4), which contains any combination of the following information: Uu RLC channel setup list, Uu RLC channel configuration, PC5 RLC channel setup list, PC5 RLC channel configuration, an indication failed to setup Uu RLC channel list, cause for failed to setup Uu RLC channel, failed to setup PC5 RLC channel list, cause for failed to setup PC5 RLC channel. In an embodiment, the Uu RLC channel and PC5 RLC channel configured by the DU1 for the relay UE are mainly used to transmit the control signaling and/or data transmitted by the remote UE through the indirect path after the multi-path configuration. After receiving the UE Context Setup Response, the CU assembles an RRCReconfiguration message to be sent to the relay UE through the DU1 (operations 5 and 6). The RRCReconfiguration message contains related configuration of the PC5 RLC channel and/or Uu RLC channel. After the Relay UE receives the information, it sends an RRCReconfigurationComplete message to the CU via the DU1 (operations 8 and 9).

In an embodiment, after completing the configuration of the relay UE and DU1, the CU sends a UE Context Modification Request message to the DU2 (operation 10), which contains the Uu DRB information of the remote UE that may need to be modified or released. That is, the UE Context Modification Request may be an adjustment for the Uu DRB configuration on the direct path after the RB or QoS flow of the remote UE originally passed through the direct path of DU1 is migrated to the indirect path. In an embodiment, the UE Context Modification Request to the DU2 may contain the configuration request of the PC5 RLC channel corresponding to the remote UE.

In an embodiment, the DU2 sends a UE Context Modification Response message to the CU (operation 11), which contains any combination of the following information: an Uu RLC channel setup list, Uu RLC channel configuration, PC5 RLC channel setup list, PC5 RLC channel configuration, an indication failed to setup Uu RLC channel list, cause for failed to setup Uu RLC channel, an indication failed to setup PC5 RLC channel list, or cause for failed to setup PC5 RLC channel. After receiving the UE Context Modification Response message, the CU assembles the RRCReconfiguration message in a UE Context Modification Request message sent to the remote UE via the DU2 (operations 12 and 13). The RRCReconfiguration message includes any combination of the following: an updated Uu DRB configuration; the remote UE identifier (e.g., a local ID assigned by the CU and/or C-RNTI assigned by the DU2); a relay UE identifier (such as an L2 ID, or a local ID or a C-RNTI allocated by the base station); a PC5 RLC channel configuration (e.g., including one or more of the following information: an identifier of a corresponding relay UE, configurations of RLC and logical channel for the PC5 RLC channel, or an identifier of a served RB.); or the bearer mapping of the Uu RB and the PC5 RLC channel.

In an embodiment, the SDAP configuration may be updated so that some QoS flows are mapped to the Uu RB associated with the PC5 RLC channel. In an embodiment, the configuration sent by the base station to remote UE can indicate at least one of the following information: a cell group identifier or a relay identifier corresponding to a primary path, a PC5 RLC channel identifier or a PC5 logical channel identifier corresponding to a primary path, a data split threshold, an indication for PDCP duplication, a cell group identifier or a relay identifier corresponding to a split secondary path, a PC5 RLC channel identifier or a PC5 logical channel identifier corresponding to a split secondary path, or a duplication status.

After the remote UE receives the RRCReconfiguration message sent by the MN, if the remote UE has not established a PC5 connection with the relay UE, the remote UE can initiate the establishment of a PC5 connection with the relay UE configured by the SN (operation 15). The remote UE then sends an RRCReconfigurationComplete message to the MN (operation 8). After that, the remote UE1 sends an RRCReconfigurationComplete message to the CU through the DU2 (operations 16 and 17). After receiving the information, the CU can update the sending path of the downlink data. In an embodiment, the remote UE can perform multi-path uplink transmission through the direct link and the indirect link according to the RRCReconfiguration sent by the MN or SN.

(1) The remote UE only accesses the relay UE initially, and subsequently accesses both of the relay UE the gNB2.

In this case, the control plane and user plane data of the remote UE are initially transmitted through the relay UE. Later, as the remote UE moves to the cell center, in order to improve the reliability of data transmission or the data transmission rate, the remote UE is configured to be able to simultaneously accesses the relay UE and gNB2 for data transmission to the network. In an embodiment, the remote UE sends (e.g., forwarded by the relay UE) the Uu measurement information (such as a cell ID, a Uu RSRP measurement result) of the gNB2 and/or the PC5 measurement result of the relay to the gNB2. In an embodiment, the remote UE can send a multi-path (such as the Uu and/or PC5 path) configuration request to the gNB2, or the remote UE sends an uplink congestion indication to the gNB2, which triggers the gNB2 to send the multi-path configuration to the remote UE. In an embodiment, the gNB2 may receive the QoS profile information of the QoS flow of the remote UE from the AMF. When the QoS flow requires a high level of PER, it may also trigger the gNB2 to send the multi-path configuration to the remote UE. In an embodiment, the gNB2 may detect that the SL resource pool is congested and the Uu resources are relatively idle, which triggers the gNB2 to send a multi-path configuration to the remote UE, allowing the remote UE to transfer part of the data flow forwarded by the relay to the Uu interface for direct transmission.

Assuming that the gNB2 determines to establish a Uu connection between the remote UE and the gNB1 and let the gNB1 serve the UE, the gNB2 can initiate the configuration of MR-DC for the remote UE, where the gNB2 is served as the MN and the gNB1 can be served as the SN. Similar to the previous scenario, the MN sends an SN Addition request to the SN, where the SN Addition request includes the target cell information and/or measurement result of the target cell. In an embodiment, the SN addition request message can include the PDU Session Resources To-Be-Added List or To-Be-Modified List corresponding to the remote UE. It can include PDU Session Resource Setup Info-SN terminated, PDU Session Resource Setup Info-MN terminated, or a PDU Session Aggregate Maximum Bit Rate of the S-NG-RAN node and other information.

After receiving the information, the SN determines the Uu RB configuration of the corresponding remote UE. In an embodiment, the SN may determine the corresponding configuration for the remote UE according to the target cell information received from the MN. After that, the SN sends an SN addition request acknowledge message to the MN, which may contain at least one of: one or more identifiers of the candidate relay UEs, one or more L2 IDs of the candidate relay UEs; C-RNTI of the candidate relay UEs; a Uu radio bearer configuration of the remote UE; a Uu RLC channel or logical channel configuration of the remote UE; a PC5 RLC channel configuration between the remote UE and relay UEs; a bearer mapping between the Uu RB of the remote UE and the Uu RLC RLC channel of the remote UE, or a bearer mapping between the Uu RB of the remote UE and the PC5 RLC channel of the emote UE. If the SN requests the MN to create a DRB of the remote UE, the MN may further send an SN Reconfiguration Complete message to the SN. After that, the MN may send an RRCReconfiguration message to the remote UE, which may include the relevant configuration of the SCG and the Uu RB configuration (for example, the PDCP of the Uu SRB of the remote UE, or the PDCP and SDAP configuration of the Uu DRB of the remote UE). The SDAP configuration includes a mapping between some QoS flows and the Uu RLC channel of the direct path. In an embodiment, the configuration sent by the MN to UE1 may indicate at least one of the following information: the cell group ID or relay UE ID corresponding to a certain Uu RB primary path, the Uu RLC channel ID or Uu logical channel ID corresponding to the primary path, a data split threshold, a PDCP duplication indication, a cell group ID corresponding to split secondary path, a Uu RLC channel ID or Uu logical channel ID corresponding to split secondary path, or duplication status.

After the remote UE receives the RRCReconfiguration message sent by the MN, it can initiate an access to the gNB2. Subsequently, the remote UE can perform a multi-path uplink transmission through the direct link and the indirect link according to the RRCReconfiguration sent by the MN.

### Example 4

This example discusses the detection of available paths and the reporting of link failures in a multi-path scenario.

When the UE performs a multi-path transmission through the direct and indirect paths, the remote UE may detect an RLF (Radio Link Failure) on the direct path. In this case, the remote UE may send a direct path RLF indication information to the base station, and the indication information may be transmitted through the indirect path. Similarly, if the UE detects an RLF on the PC5 link on the indirect path or the remote UE receives the Uu RLF indication information sent by the relay UE, the remote UE can send the indirect path RLF information to the base station. In this case, the remote UE can send the indirect path RLF indication information to the base station through the direct path.

In an embodiment, the direct path RLF indication or indirect path RLF indication may include at least one of the following: information of Uu link failure, information of PC5 link failure, information of UE to UE link failure, or failure cause. If the UE is configured with more than one direct path or indirect path, the direct path RLF indication or indirect path RLF indication may further include the relay UE identifier corresponding to the PC5 link or UE to UE link, the MCG identifier, SCG identifier, cell identifier, or DU identifier corresponding to the Uu link.

In an embodiment, if the relay UE detects that an RLF occurs on the PC5 link between the relay UE and the remote UE, the relay UE may send a PC5 link RLF indication to the base station. It may contain the corresponding remote UE identifier.

### Example 5

This example discusses the configuration required by the remote UE for multi-path transmission in the L3 U2N relay scenario.

In the case of L3 relay, the PDCP layer of the data packet transmitted via the indirect link of the remote UE is terminated at the relay UE, and the PDCP layer of the data packet transmitted via the direct link of the remote UE is terminated at the gNB. In this scenario, if the multi-path transmission of the remote UE is supported, the remote UE may decide which QoS flows are transmitted via the direct path and which QoS flows are transmitted via the indirect path. In an embodiment, the QoS flow transmitted through the indirect path may be invisible to the base station. Thus, it is difficult for the data packets of the same QoS flow to be transmitted through multi-path and then perform PDCP layer packet ordering and duplicated packet discarding at the base station. Therefore, the granularity of multi-path is difficult to achieve per RB granularity and CP-UP separated granularity. In an embodiment, the CP RRC signaling between the remote UE and the base station can only be transmitted through the direct path, and cannot be transmitted through the indirect path. In an embodiment, the data split or data duplication functions on different paths of the same RB data packet corresponding to the multi-path cannot be supported by the L2 U2N relay.

For scenarios where data packets of different QoS flows are transmitted through different paths, the base station can provide path selection policies for the remote UE. For example, the remote UE reports the multi-path capability or indication to the base station. The base station may send path selection configurations to the remote UE. The path selection configuration can include information of QoS, a PC5 link quality, and/or a congestion level in the sidelink resource pool. For example, the path selection configuration received by the remote UE from the base station may include at least one of the following information: a PC5 QoS profile, a PC5 link quality, a CBR (Channel Busy Ratio), or an available path. The available path can include the direct path (such as the Uu path), the indirect path (such as the PC5 path), or both of the direct and indirect paths. If the UE detects that the available path corresponding to a QoS flow that conforms to the path selection configuration is both of the direct and indirect paths, the UE may decide to use the direct path and/or the indirect path to initiate the data transmission.

In some embodiments, upon receiving the path selection configuration, the UE may select the available path. For example, if the Uu QoS profile of remote UE's QoS flow matches one of the Uu QoS profile in the path selection configuration and the available path corresponding to this Uu QoS profile is an indirect path, the remote UE shall select the indirect path for the data transmission.

On the other hand, if the measured Uu link quality is higher than the configured Uu link quality threshold and or the PC5 link quality is higher than the configured PC5 link quality threshold, the configured available path for this scenario is a direct and an indirect path, the remote UE should select the indirect path and the direct path for the data transmission.

In this case, the path selection configuration may further include the primary path and or secondary path indication, data split threshold, data duplication indication etc.

For example, if the path selection configuration for a given link quality and or CBR and or Qos combination is a direct and an indirect path, the remote UE may determine whether to split the data traffic or perform data duplication based on the data split threshold or data duplication indication. Suppose a data split threshold is configured, the remote UE splits the traffic based on the data split threshold and primary path and secondary path indication. To be specific, the remote UE firstly delivers data traffic via the primary path (for example, the direct path). Later, when the data traffic is higher than the data split threshold, the remote UE may deliver the data traffic via either primary path or secondary path (for example, the indirect path).

In some embodiments, the remote UE selects the available path according to the path configuration. In some embodiments, if a measured Uu link quality is higher than the Uu link quality threshold and the available path comprises the direct path, the remote UE selects the direct path if a measured Uu link quality is higher than the Uu link quality threshold and the available path comprises the direct path, the remote UE selects the direct path as the available path.

In some embodiments, if at least one of a measured PC5 link quality is higher than the PC5 link quality threshold or a measured CBR is lower than the CBR in the path configuration, and if the available path comprises the indirect path, the remote UE selects the indirect path as the available path.

In some embodiments, if the measured Uu link quality is higher than the Uu link quality threshold, the measured PC5 link quality is higher than the PC5 link quality threshold, and the available path comprises both of the direct path and indirect path, the remote UE determines to split a data traffic to the direct path and the indirect path according to the data split threshold, the primary path indication, and the secondary path indication.

In some embodiments, if the measured Uu link quality is higher than the Uu link quality threshold, the measured PC5 link quality is higher than the PC5 link quality threshold, and the available path comprises both of the direct path and indirect path, the remote UE determines to perform data duplication on the direct path and the indirect path according to the data duplication indication.

In some embodiments, if the QoS profile of the data to be transmitted matches one of the configured QoS profile, the remote UE selects the path based on the configured available path.

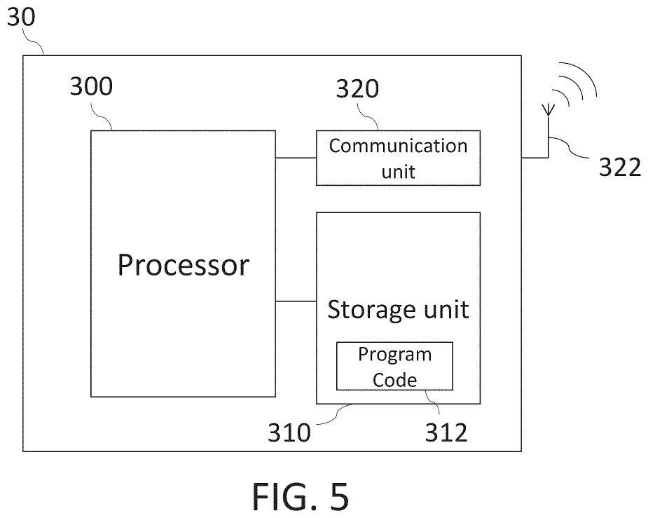

FIG. 5 relates to a schematic diagram of a wireless communication terminal 30 (e.g., a terminal node or a terminal device) according to an embodiment of the present disclosure. The wireless communication terminal 30 may be a user equipment (UE), a remote UE, a relay UE, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE or the relay UE described above. In some embodiments, the processor 300 and the communication unit 320 collaboratively perform the operations described above. For example, the processor 300 performs operations and transmit or receive signals, message, and/or information through the communication unit 320.

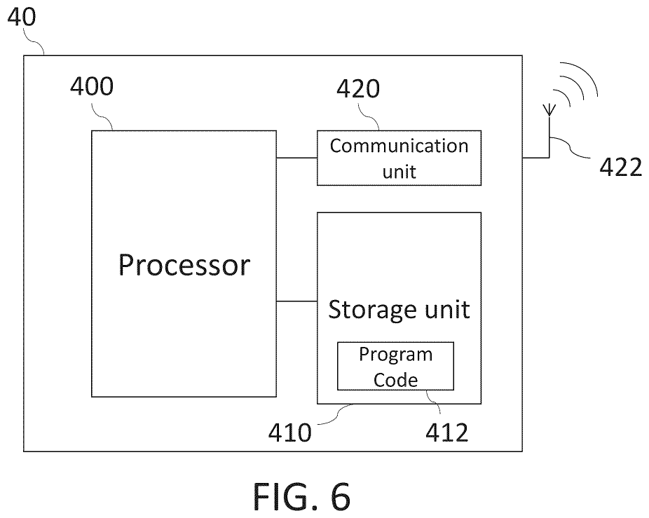

FIG. 6 relates to a schematic diagram of a wireless communication node 40 (e.g., a network device) according to an embodiment of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB1, the gNB2, or the CU described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a remote UE). In an embodiment, the wireless communication terminal may be implemented by using the wireless communication terminal 30 described above, but is not limited thereto.

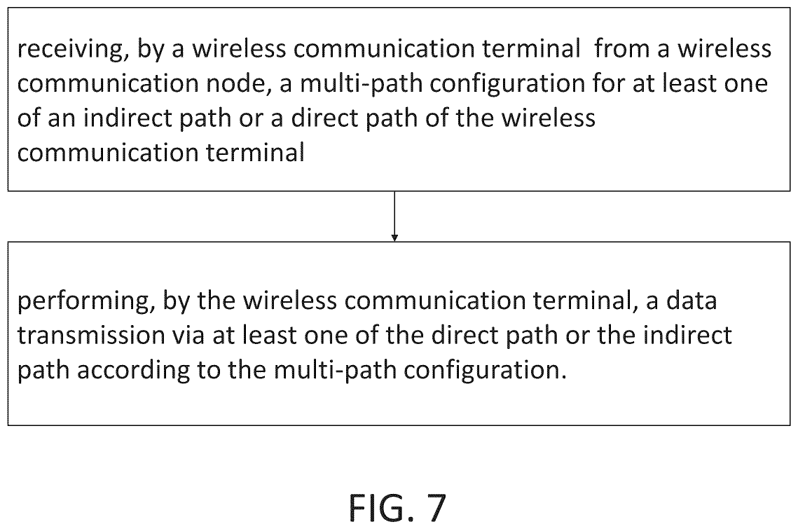

Referring to FIG. 7, in an embodiment, the wireless communication method includes: receiving, by a wireless communication terminal from a wireless communication node, a multi-path configuration for at least one of an indirect path or a direct path of the wireless communication terminal; and performing, by the wireless communication terminal, a data transmission via at least one of the direct path or the indirect path according to the multi-path configuration.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described above, but is not limited thereto.

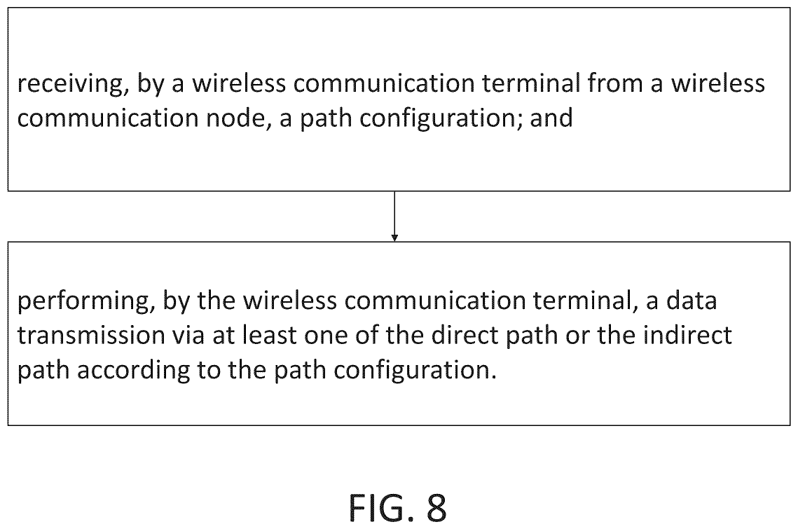

Referring to FIG. 8, in an embodiment, the wireless communication method includes: receiving, by a wireless communication terminal from a wireless communication node, a path configuration; and performing, by the wireless communication terminal, a data transmission via at least one of the direct path or the indirect path according to the path configuration.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB, which can be the gNB2 described above). In an embodiment, the wireless communication terminal may be implemented by using the wireless communication node 40 described above, but is not limited thereto.

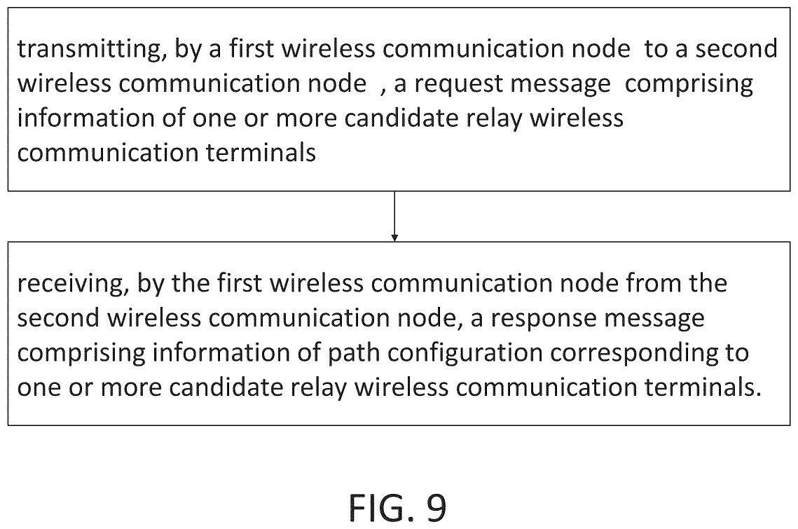

Referring to FIG. 9, in an embodiment, the wireless communication method includes: transmitting, by a first wireless communication node to a second wireless communication node, a request message comprising information of one or more candidate relay wireless communication terminals; and receiving, by the first wireless communication node from the second wireless communication node, a response message comprising information of path configuration corresponding to one or more candidate relay wireless communication terminals.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB, which can be the gNB1 described above). In an embodiment, the wireless communication terminal may be implemented by using the wireless communication node 40 described above, but is not limited thereto.

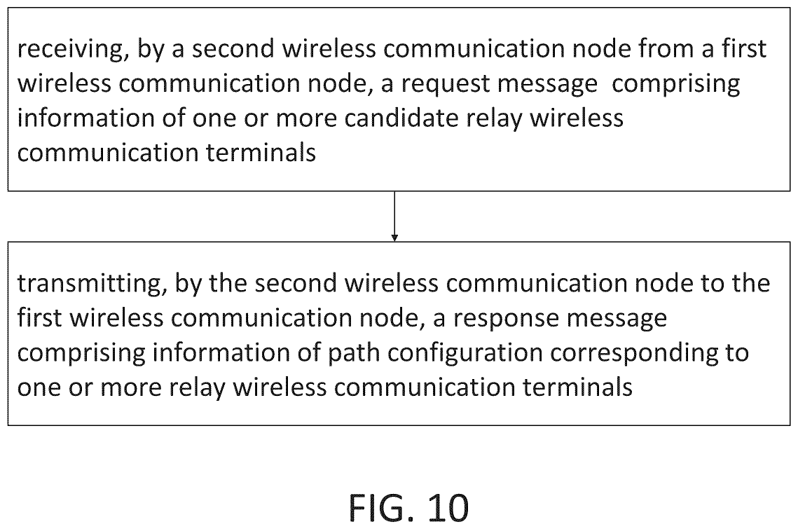

Referring to FIG. 10, in an embodiment, the wireless communication method includes: receiving, by a second wireless communication node from a first wireless communication node, a request message comprising information of one or more candidate relay wireless communication terminals; and transmitting, by the second wireless communication node to the first wireless communication node, a response message comprising information of path configuration corresponding to one or more relay wireless communication terminals.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1.-48. (canceled)

49. A wireless communication method comprising:
receiving, by a wireless communication terminal from a wireless communication node, a multi-path configuration for at least one of an indirect path or a direct path of the wireless communication terminal; and
performing, by the wireless communication terminal, a data transmission via at least one of the direct path or the indirect path according to the multi-path configuration.

50. The wireless communication method of claim 49, wherein the direct path is a link between the wireless communication terminal and the wireless communication node via a Uu interface;
wherein the indirect path is a path comprising one or more first links and a second link, wherein the first links are wireless-communication-terminal-to-wireless-communication-terminal links, and the second link is between the wireless communication terminal and the wireless communication node via a Uu interface;
wherein the first links are links based on direct communication technologies.

51. The wireless communication method of claim 49, wherein the multi-path configuration comprises a path indication comprising at least one of:
an indication of at least one of the direct path or the indirect path,
a path identifier,
a relay wireless communication terminal identifier or aggregated wireless communication terminal identifier, or
an identifier of a corresponding cell or base station.

52. The wireless communication method of claim 49, wherein the multi-path configuration comprises a path indication comprising at least one of:
an identifier of SRB or DRB;
a path indication corresponding to at least one of the indirect path or the direct path, a primary path indication, a secondary path indication,
a path identifier,
a cell group identifier corresponding to a direct path, a primary path or a secondary path,
a relay wireless communication terminal identifier or aggregated wireless communication terminal identifier corresponding to an indirect path, a primary path or a secondary path,
a PC5 RLC channel identifier or a PC5 logical channel identifier corresponding to the direct path, indirect path, primary path or secondary path,
a Uu logical channel identifier corresponding to the direct path, indirect path, primary path or secondary path,
a data split threshold, or
a data duplication indication.

53. The wireless communication method of claim 49, wherein the multi-path configuration comprises a path indication comprising at least one of:
an indication of at least one of the direct path or the indirect path,
a path identifier,
a relay wireless communication terminal identifier or aggregated wireless communication terminal identifier for indirect path,
an identifier of a corresponding cell or base station for direct path, or
a CP or UP indication.

54. The wireless communication method of claim 49, wherein the multi-path configuration comprises at least one of:
information for setting up, modifying, or releasing the direct or indirect path, information of conflict-free random access resources corresponding to 4-step or 2-step random access type of the wireless communication terminal in the direct path,
a Uu RB configuration,
a PC5 Radio link Control, RLC, channel configuration,
a Uu RLC channel or logical channel configuration,
a bearer mapping between the Uu RB and the PC5 RLC channel, or
a bearer mapping between the Uu RB and the Uu RLC channel.

55. The wireless communication method of claim 54, wherein the PC5 RLC channel or bearer configuration comprises at least one of:
a corresponding relay wireless communication terminal identifier or aggregated wireless communication terminal identifier,
configurations of logical channel for the PC5 RLC channel,
or an identifier of one or more served RBs.

56. The wireless communication method of claim 54, wherein the Uu RB configuration comprises at least one of:
a Packet Data Convergence Protocol, PDCP, configuration of a Uu SRB of the wireless communication terminal,
or a PDCP configuration of a Uu DRB of the wireless communication terminal;
or a Service Data Adaption Protocol, SDAP, configuration of a Uu DRB of the wireless communication terminal;
and wherein the SDAP configuration comprises configurations for mapping of Quality of Service, QoS, flows to a Uu DRB.

57. The wireless communication method of claim 54, wherein the wireless communication terminal transmits a data packet corresponding to a Uu RB to at least one of a PC5 interface or a Uu interface of the wireless communication terminal according to the Uu RB configuration.

58. The wireless communication method of claim 49, wherein the wireless communication terminal transmits a multi-path request to the wireless communication node;
wherein the multi-path request comprises at least one of: a multi-path capability, a measurement result for a relay wireless communication terminal, a request for saving power, or a path request for at least one of the direct or indirect path.

59. The wireless communication method of claim 49, wherein the wireless communication terminal performs a conflict-free random access procedure on the direct path according to the multi-path configuration.

60. The wireless communication method of claim 49, wherein the wireless communication terminal performs at least one of the following operations according to the multi-path configuration: setting up at least one of the direct or indirect path, modifying at least one of the direct or indirect path, or releasing at least one of the direct or indirect path.

61. The wireless communication method of claim 49, wherein the wireless communication terminal receives an activation or deactivation indication, to activate or deactivate at least one of the direct path or the indirect path;
wherein the activation or deactivation indication comprises at least one of:
a Radio Bearer, RB, identifier,
a path identifier,
an indication for activation or deactivation,
a direct path,
an indirect path,
a primary path,
a secondary path,
an indication of uplink transmission,
an indication of downlink transmission,
a Uu RLC channel identifier or a Uu logical channel identifier, or
a PC5 RLC channel identifier or a PC5 logical channel identifier.

62. The wireless communication method of claim 49, wherein the wireless communication terminal receives one or more routing identifiers corresponding to a Uu RB, and the routing identifier comprises at least one of a target identifier or a path identifier.

63. The wireless communication method of claim 49, wherein the wireless communication terminal receives routing information comprising at least one of: a target identifier, a path identifier, a next hop node identifier, a next hop node type, a hop count, a priority, or a weight value.

64. The wireless communication method of claim 49, wherein the wireless communication terminal determines a next hop node according to a routing identifier, determines at lease one of a PC5 RLC channel or a Uu RLC channel according to a bearer mapping configuration, and
delivers a data packet of corresponding Uu DRB to at least one of the PC5 RLC channel or Uu RLC channel.

65. The wireless communication method of claim 49, wherein the wireless communication terminal transmits a direct path Radio Link Failure, RLF, indication or an indirect path RLF indication to the wireless communication node;
wherein the direct path RLF indication or the indirect path RLF indication further comprises at least one of: a relay wireless communication terminal identifier or aggregated wireless communication terminal identifier corresponding to a PC5 link or wireless communication terminal to wireless communication terminal link, or an MCG identifier or SCG identifier or cell identifier or distributed unit identifier corresponding to a Uu link.

66. The wireless communication method of claim 49, wherein the direct path RLF indication is transmitted to the wireless communication node via the indirect path;
wherein the indirect path RLF indication is transmitted to the wireless communication node via the direct path;
wherein the direct path RLF indication or the indirect path RLF indication comprises at least one of: a Uu link failure, a PC5 link failure, a wireless communication terminal to wireless communication terminal link failure, or a failure cause.

67. A wireless communication terminal comprising a processor configured to cause the wireless communication terminal to:
receive, from a wireless communication node, a multi-path configuration for at least one of an indirect path or a direct path of the wireless communication terminal; and
perform a data transmission via at least one of the direct path or the indirect path according to the multi-path configuration.

68. A computer program product comprising a computer-readable program medium code stored thereupon, the code, when executed by a processor, causing the processor to implement a wireless communication method, comprising:
receiving, by a wireless communication terminal from a wireless communication node, a multi-path configuration for at least one of an indirect path or a direct path of the wireless communication terminal; and
performing, by the wireless communication terminal, a data transmission via at least one of the direct path or the indirect path according to the multi-path configuration.
